(19) United States
(12) Patent Application Publication
(10) Pub. No.: US 2020/0272250 A1
(43) Pub. Date: Aug. 27, 2020

(54) POINTING BODY, METHOD OF CONTROLLING POINTING BODY, AND INTERACTIVE SYSTEM

(71) Applicant: SEIKO EPSON CORPORATION, Tokyo (JP)

(72) Inventor: Yukihiro KARASAWA, Azumino-shi (JP)

(73) Assignee: SEIKO EPSON CORPORATION, Tokyo (JP)

(21) Appl. No.: 16/797,008

(22) Filed: Feb. 21, 2020

(30) Foreign Application Priority Data
Feb. 22, 2019 (JP) 2019-030232

(51) Int. Cl. G06F 3/0354; G06F 3/0346; G06F 3/042; G06F 3/038

(52) U.S. Cl. CPC G06F 3/03542; G06F 3/0386; G06F 3/0425; G06F 3/0346

(57) ABSTRACT

The pointing body includes a receiving section configured to receive a sync signal periodically transmitted from a projector, a processing section configured to perform a process in sync with the sync signal received by the receiving section, and a control section configured to control supply of power to the receiving section, wherein the control section predicts timing when the sync signal is transmitted based on the sync signal received by the receiving section, and switches between a first period in which the power is supplied to the receiving section and a second period in which supply of the power to the receiving section is restricted based on the timing predicted.

The present application is based on, and claims priority from JP Application Serial Number 2019-030232, filed Feb. 22, 2019, the disclosure of which is hereby incorporated by reference herein in its entirety.

### BACKGROUND

### 1. Technical Field

The present disclosure relates to a pointing body, a method of controlling a pointing body, and an interactive system.

### 2. Related Art

There has been known an interactive system including a projector for projecting an image on a projection surface, and a pointing body such as a light emitting pen for pointing above the projection surface, and capable of taking an image of the projection surface to detect a pointing position of the pointing body. In JP-A-2015-158883, there is described a pointing body which receives a sync signal as an infrared ray transmitted from a projector to emit light in sync with the sync signal received. This pointing body is arranged to be able to make the transition of an operation mode from a normal mode to a power saving mode to thereby decrease the power consumption of the pointing body when the sync signal from the projector is not received for a predetermined time and so on, and elongate the operable time of the pointing body operating using a battery as a power supply.

However, in this pointing body, since the state capable of receiving the sync signal is continuously be kept in the normal mode, there is a limitation in reducing the power consumption. Therefore, in order to further elongate the operable time of the pointing body, it is required to reduce the power consumption during the operation in the normal mode.

### SUMMARY

A pointing body according to the present disclosure is a pointing body configured to point an image displayed including a receiving section configured to receive a sync signal periodically transmitted, a processing section configured to perform a process in sync with the sync signal received by the receiving section, and a control section configured to control supply of power to the receiving section, wherein the control section predicts timing when the sync signal is transmitted based on the sync signal received by the receiving section, and switches between a first period in which the power is supplied to the receiving section and a second period in which supply of the power to the receiving section is restricted based on the timing predicted.

In the pointing body described above, the sync signal may include a first sync signal, and a second sync signal to be transmitted at a predetermined interval with the first sync signal.

In the pointing body described above, when a predetermined time elapsed while the receiving section fails to receive the sync signal, the control section may make a transition to a first receiving mode in which the supply of the power to the receiving section is continued to watch reception of the sync signal by the receiving section.

In the pointing body described above, when the control section received the sync signal during the first receiving mode, the control section may re-predict the timing when the sync signal is transmitted.

In the pointing body described above, the processing section may perform a process of emitting detection light in sync with the sync signal.

A method of controlling a pointing body according to the present disclosure is a method of controlling a pointing body configured to point an image displayed including the steps of receiving, with a receiving section, a sync signal periodically transmitted, predicting timing when the sync signal is transmitted based on the sync signal received, and switching, based on the timing predicted, between a first period in which power is supplied to the receiving section and a second period in which supply of the power to the receiving section is restricted.

In the method of controlling a pointing body described above, the sync signal may include a first sync signal, and a second sync signal to be transmitted at a predetermined interval with the first sync signal.

In the method of controlling a pointing body described above, when a predetermined time elapsed while the receiving section fails to receive the sync signal, a transition to a first receiving mode in which the supply of the power to the receiving section is continued to watch reception of the sync signal by the receiving section may be made.

In the method of controlling a pointing body described above, when the sync signal was received during the first receiving mode, the timing when the sync signal is transmitted may be re-predicted.

In the method of controlling a pointing body described above, detection light may be emitted in sync with the sync signal received by the receiving section.

An interactive system according to the present disclosure includes the pointing body described above, and a projector having a sync signal transmitting section configured to transmit the sync signal to the pointing body, an image projection section configured to project the image, and an imaging section configured to take the image in sync with the sync signal.

### BRIEF DESCRIPTION OF THE DRAWINGS

FIG. 1 is a perspective view showing a configuration of an interactive system.

FIG. 2 is a block diagram showing a schematic configuration of a projector.

FIG. 3 is a block diagram showing a schematic configuration of an image projection section provided to the projector.

FIG. 4 is a block diagram showing a schematic configuration of a light emitting pen.

FIG. 5 is a timing chart showing an operation timing of the interactive system.

FIG. 6 is a flowchart showing a method of controlling the light emitting pen.

### DESCRIPTION OF AN EXEMPLARY EMBODIMENT

A pointing body, a method of controlling a pointing body, and an interactive system according to the embodiment will hereinafter be described with reference to the drawings.

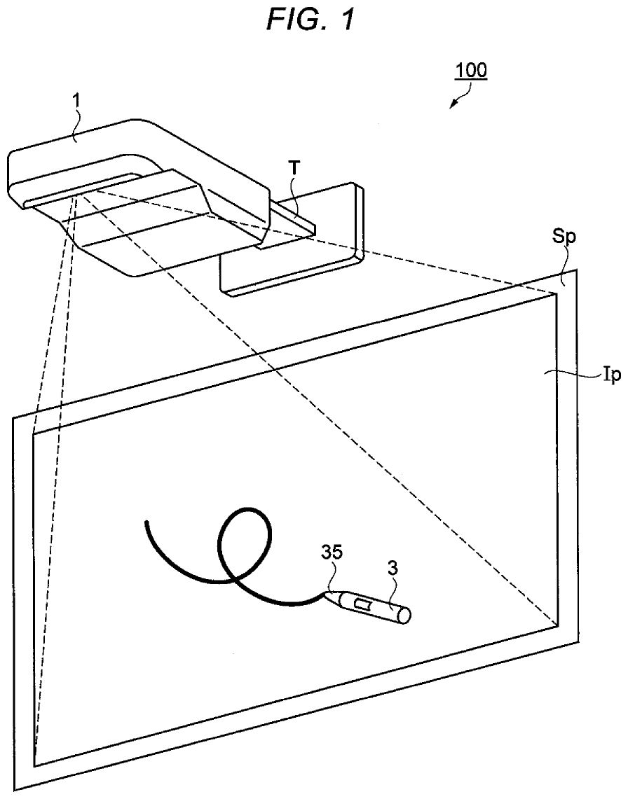

FIG. 1 is a perspective view showing a configuration of the interactive system according to the present embodiment. The configuration of the interactive system will hereinafter be described with reference to FIG. 1.

As shown in FIG. 1, the interactive system 100 is provided with a projector 1 and a light emitting pen 3 as a pointing body. A projection image Ip based on image information input from the outside or image information previously stored inside is projected by the projector 1 on a projection surface Sp as a display surface.

The projector 1 according to the present embodiment is fixed to a wall surface via a fixation member T, and projects an image toward the projection surface Sp disposed along the same wall surface. As the projection surface Sp, there can be used, for example, a screen or a whiteboard, but it is also possible to adopt a configuration of projecting the image on the wall surface itself.

Further, the projector 1 is made capable of taking an image of a range including the projection image Ip projected on the projection surface Sp. The projector 1 images the infrared light emitted from a light emitting section 35 on a tip of the light emitting pen 3, and then, detects a pointing position pointed by the light emitting pen 3 within the projection image Ip based on the position of the light. Further, it is possible for the projector 1 to display a pointer so as to be superimposed on the pointing position thus detected, or to display a drawn image in which a line is drawn along the trajectory of the pointing position so as to be superimposed. It should be noted that the light emitting pen 3 is assumed to emit infrared light in the present embodiment, but can be provided with a configuration of emitting light in another wavelength band.

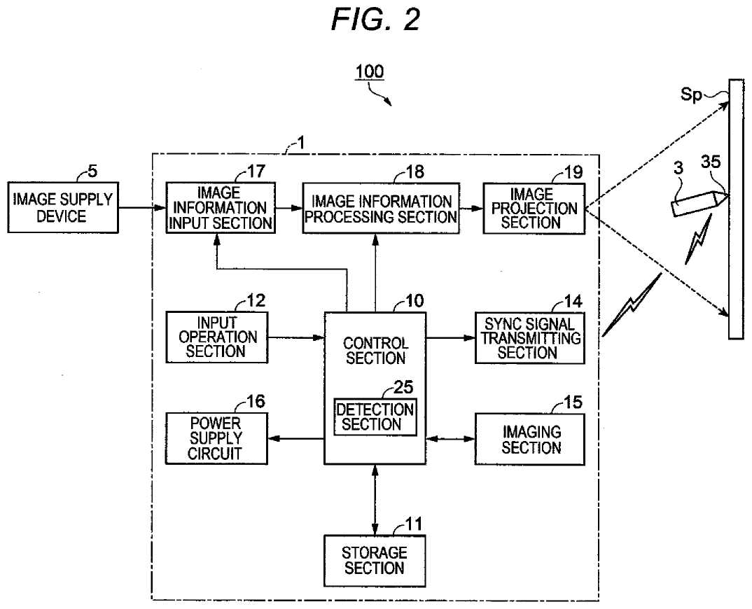

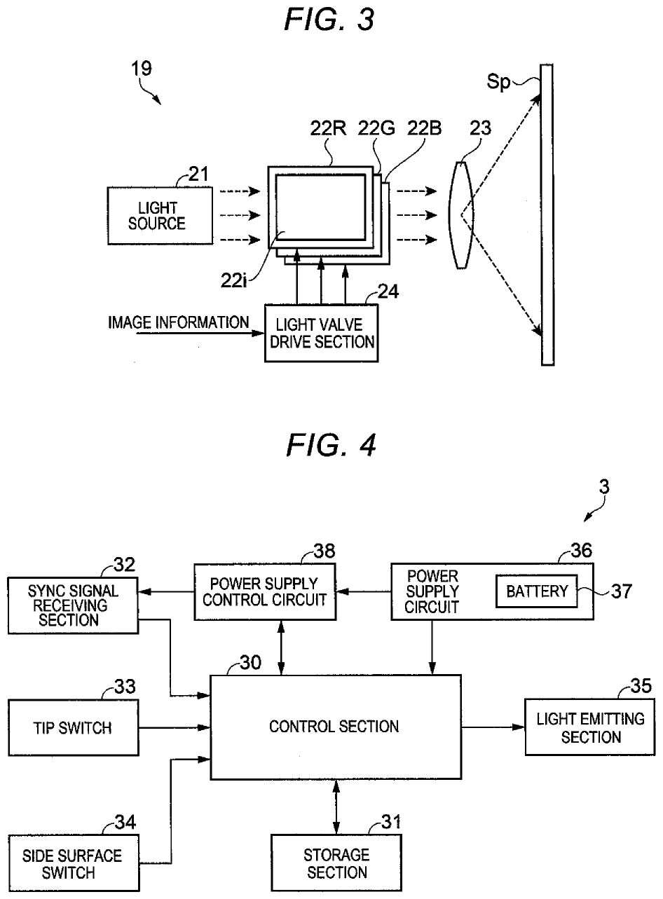

FIG. 2 is a block diagram showing a schematic configuration of the projector. FIG. 3 is a block diagram showing a schematic configuration of an image projection section provided to the projector. The schematic configuration of the projector and the schematic configuration of the image projection section will hereinafter be described with reference to FIG. 2 and FIG. 3.

As shown in FIG. 2, the projector 1 is configured integrally including a control section 10, a storage section 11, an input operation section 12, a sync signal transmission section 14 as a transmission section, an imaging section 15, a power supply circuit 16, an image information input section 17, an image information processing section 18, and an image projection section 19. The projector 1 projects an image from the image projection section 19 on the projection surface Sp based on the image information input to the image information input section 17.

The control section 10 is configured including one processor or a plurality of processors, and operates in accordance with a control program stored in the storage section 11 to thereby integrally control the operation of the projector 1.

The storage section 11 is configured including memory devices such as a random access memory (RAM) and a read only memory (ROM). The RAM is used for temporary storage of a variety of types of data, and the ROM stores the control program, control data and so on for controlling the operation of the projector 1. Further, it is also possible for the storage section 11 to store the image information to be projected from the image projection section 19.

The input operation section 12 is provided with a plurality of operation keys for the user to make a variety of instructions to the projector 1. As the operation keys provided to the input operation section 12, there are cited a power key for switching between ON and OFF of the power, a menu key for displaying a menu image for performing a variety of types of setting, directional keys for selecting items on the menu image, and so on. When the user operates a variety of operation keys of the input operation section 12, the input operation section 12 outputs an operation signal corresponding to the operation content by the user to the control section 10. It should be noted that it is also possible to adopt a configuration of using a remote controller not shown capable of a remote operation as the input operation section 12. In this case, the remote controller transmits an operation signal of an infrared ray corresponding to the operation content by the user, and then a remote control signal receiving section not shown receives the operation signal to transmit the operation signal to the control section 10.

The sync signal transmitting section 14 has a light emitting section for transmitting a sync signal as a signal for synchronization to the light emitting pen 3. As a light source of the light emitting section, there is used, for example, a light emitting diode (LED) for emitting the infrared light. The sync signal transmitting section 14 periodically makes the light emitting section emit light based on the control by the control section 10 to thereby transmit the sync signal of the infrared light to the light emitting pen 3. The light emitting pen 3 periodically receives the sync signal, and then repeatedly makes the light emitting section 35 emit light at timing synchronous with the sync signal thus received.

The imaging section 15 is a camera provided with an imaging element not shown such as a CCD (Charge Coupled Device) sensor or a CMOS (Complementary Metal Oxide Semiconductor) sensor. The imaging section 15 has an infrared transmission filter for absorbing visible light and transmitting infrared light, and images the infrared light emitted from the light emitting pen 3 via the infrared transmission filter.

Further, the imaging section 15 takes the image of a range including the projection image Ip on the projection surface Sp based on the control by the control section 10, and then outputs image information (taken image information) as the imaging result to the control section 10. The control section 10 makes the imaging section 15 perform imaging at timing synchronous with the sync signal transmitted by the sync signal transmitting section 14. In other words, the imaging section 15 repeats imaging in accordance with the timing at which the light emitting pen 3 emits light.

The control section 10 of the projector 1 is provided with a detection section 25 as a functional block realized by the control program. The detection section 25 detects the infrared light emitted by the light emitting pen 3 out of the image thus taken based on the taken image information input from the imaging section 15. The detection section 25 detects a figure having the luminance no lower than a predetermined threshold value and the size no smaller than a predetermined threshold value out of the figures of the infrared light included in the image thus taken assuming as the light emitted by the light emitting pen 3, and does not detect the other figures assuming as noises.

The power supply circuit 16 is externally supplied with the commercial power not shown of 100 V AC or the like. The power supply circuit 16 converts the alternating-current commercial power into direct-current power of a predetermined voltage, and supplies each section of the projector 1 with the power. The control section 10 is capable of controlling the power supply circuit 16 to start and stop the power supply to each section.

The image information input section 17 is connected to an image supply device 5 located outside such as a computer or an image reproduction device to receive supply of the image information from the image supply device 5. Further, it is possible for the image information input section 17 to be supplied with the image information stored in the storage section 11 from the control section 10. The image information thus input is output by the image information input section 17 to the image information processing section 18.

Based on the control by the control section 10, the image information processing section 18 performs a variety of types of processing on the image information input from the image information input section 17, and then outputs the image information having been processed to a light valve drive section 24 (see FIG. 3) of the image projection section 19. For example, the image information processing section 18 performs a process of adjusting the image quality such as luminance or contrast, a process of correcting a distortion of the image, a process of superimposing an OSD (on-screen display) image such as a pointer, a drawn image, or a menu image, and the like on the image information as needed.

It should be noted that the image information input section 17 and the image information processing section 18 can be constituted by a single processor, a plurality of processors, or the like, or can also be constituted by a dedicated processing device such as an ASIC (Application Specific Integrated Circuit) or an FPGA (Field Programmable Gate Array).

As shown in FIG. 3, the image projection section 19 is configured including a light source 21, three liquid crystal light valves 22R, 22G, and 22B as light modulation devices, a projection optical system 23, the light valve drive section 24 and so on. The image projection section 19 modulates the light emitted from the light source 21 with the liquid crystal light valves 22R, 22G, and 22B to thereby form image light, and then projects the image light from the projection optical system 23 including at least one of a lens and a mirror to thereby display the image on the projection surface Sp.

The light source 21 is configured including a discharge type light source lamp such as a super high-pressure mercury lamp or a metal halide lamp, or a solid-state light source such as a light emitting diode or a semiconductor laser. The light emitted from the light source 21 is converted into the light having a substantially uniform intensity distribution by an integrator optical system not shown, and is then separated into colored light components of red (R), green (G), and blue (B), the three primary colors of light, by a color separation optical system not shown, and then the colored light components respectively enter the liquid crystal light valves 22R, 22G, and 22B.

The liquid crystal light valves 22R, 22G, and 22B are each formed of a transmissive liquid crystal panel having a liquid crystal material encapsulated between a pair of transparent substrates, and so on. The liquid crystal panels are each provided with a rectangular image forming area 22i constituted by a plurality of pixels arranged in a matrix, and are each arranged so that a drive voltage can be applied to the liquid crystal material pixel by pixel.

The light valve drive section 24 forms an image in the image forming area 22i of each of the liquid crystal light valves 22R, 22G, and 22B. Specifically, the light valve drive section 24 applies the drive voltages corresponding to the image information input from the image information processing section 18 to the respective pixels in the image forming areas 22i to thereby set the pixels to respective light transmission rates corresponding to the image information. The light emitted from the light source 21 is transmitted through the image forming area 22i of each of the liquid crystal light valves 22R, 22G, and 22B to thereby be modulated pixel by pixel, and thus the image light corresponding to the image information is formed for each of the colored light beams. The colored light beams as the image light of the respective colors thus formed are combined with each other pixel by pixel by a color composition optical system not shown to turn to the image light representing a color image, and the image light is then projected on the projection surface Sp by the projection optical system 23 in an enlarged manner. As a result, on the projection surface Sp, there is displayed the projection image Ip based on the image information input to the image information input section 17.

FIG. 4 is a block diagram showing a schematic configuration of the light emitting pen. The schematic configuration of the light emitting pen will hereinafter be described with reference to FIG. 4.

As shown in FIG. 4, the light emitting pen 3 is configured including a control section 30, a storage section 31, a sync signal receiving section 32 as a receiving section, a tip switch 33, a side surface switch 34, a light emitting section 35 as a processing section, a power supply circuit 36, and a power supply control circuit 38. The power supply circuit 36 includes a battery 37.

The control section 30 is configured including a single processor or a plurality of processors, and operates in accordance with a control program stored in the storage section 31 to thereby integrally control the operation of the light emitting pen 3.

The storage section 31 is constituted by a memory or the like for storing the control program, control data, and so on for controlling the operation of the light emitting pen 3.

The sync signal receiving section 32 is formed of a light receiving element or the like for receiving infrared light, receives the sync signal as the infrared light periodically transmitted from the sync signal transmitting section 14 of the projector 1 to convert the sync signal into an electric signal, and then outputs the electric signal to the control section 30.

The tip switch 33 is disposed on the tip part of the light emitting pen 3, and detects pressing of the tip part to output the detection result to the control section 30 when the operation of pressing the tip part against the projection surface Sp is performed.

The side surface switch 34 detects the pressing operation by the user on the operation button disposed on the side surface of the light emitting pen 3, and then outputs the detection result to the control section 30.

The light emitting section 35 is configured including a light source (e.g., an LED) disposed in the vicinity of the tip part of the light emitting pen 3, and emits the infrared light as the detection light based on the control by the control section 30. The control section 30 makes the light emitting section 35 emit light periodically or intermittently in sync with the sync signal periodically received by the sync signal receiving section 32.

The power supply circuit 36 is provided with the battery 37, and converts the direct-current power supplied from the battery 37 into one in a predetermined voltage to supply each section of the light emitting pen 3 with the power. It should be noted that the illustration of the supply channel to each section other than the power supply control circuit 38 for controlling the supply of the power to the sync signal receiving section 32 will be omitted. The control section 30 is capable of controlling the power supply circuit 36 or the supply channel thereof to start or stop the power supply to each section, and the light emitting section 35 performs light emission due to the power supplied from the power supply circuit 36.

The battery 37 is, for example, a primary cell housed in a replaceable manner, and supplies the power supply circuit 36 with the power. It should be noted that as the battery 37, it is possible to adopt a secondary cell which can be recharged.

The power supply control circuit 38 supplies the power of the power supply circuit 36 to the sync signal receiving section 32, or stops supply of the power due to the control by the control section 30. The power supply control circuit 38 is formed of a switching element such as an FET (Field Effect Transistor).

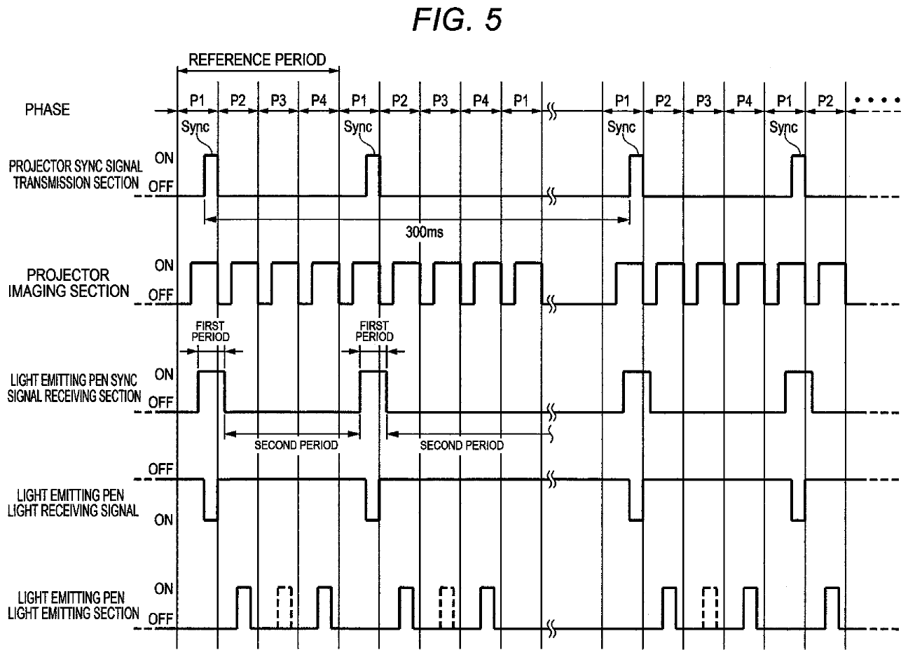

FIG. 5 is a timing chart showing an operation timing of the interactive system. The operation timing of the interactive system will hereinafter be described with reference to FIG. 5.

The timing chart shown in FIG. 5 represents the timing when the sync signal transmitting section 14 of the projector 1 transmits (emits light of) the sync signal Sync, the timing when the imaging section 15 of the projector 1 performs imaging, the timing when the sync signal receiving section 32 of the light emitting pen 3 is switched ON or OFF, the timing when the light receiving signal of the light emitting pen 3 is switched ON or OFF, and the timing when the light emitting section 35 of the light emitting pen 3 emits light in descending order. In FIG. 5, the horizontal axis corresponds to a time axis, and the vertical axis represents a state of each of the operations.

As shown in FIG. 5, the imaging section 15 of the projector 1 repeats imaging with a predetermined period. Here, assuming that the period of imaging is called a “phase,” the projector 1 and the light emitting pen 3 repeat substantially the same operation every reference period constituted by four phases, namely a first phase P1, a second phase P2, a third phase P3, and a fourth phase P4. In the present embodiment, the period of imaging, namely the length of each of the phases, is about 9.4 millisecond.

The first phase P1 is a phase for synchronization, and the sync signal transmitting section 14 of the projector 1 transmits the sync signal Sync formed of a pulse signal to the light emitting pen 3. The sync signal transmitting section 14 transmits the sync signal Sync in the first phase P1 of the two continuous reference periods out of 32 phases, namely 8 reference periods, and does not transmit the sync signal Sync in the subsequent 6 reference periods. In other words, the sync signal transmitting section 14 transmits the sync signal Sync twice in the period of 32 phases, namely in the period of about 300 milliseconds, and thereafter, this operation is repeated periodically.

The imaging section 15 of the projector 1 performs imaging in the predetermined imaging period in each of the phases P1 through P4 in sync with the sync signal Sync. The imaging period of the imaging section 15 in each of the phases P1 through P4 is, for example, a period of about 1.4 millisecond.

The control section 30 of the light emitting pen 3 predicts the timing when the subsequent sync signal Sync is transmitted based on the sync signal Sync having been received twice, and then performs the control so that the power is supplied to the sync signal receiving section 32 in the period in which the sync signal Sync is transmitted, and the power is not supplied to the sync signal receiving section 32 in the period in which the sync signal Sync is not transmitted. Specifically, the control section 30 controls the power supply control circuit 38 to supply the sync signal receiving section 32 with the power at the timing before the sync signal Sync is transmitted from the projector 1. In other words, the sync signal receiving section 32 starts up and is switched ON before receiving the sync signal Sync. Meanwhile, the control section 30 of the light emitting pen 3 controls the power supply control circuit 38 to stop the supply of the power to the sync signal receiving section 32 at the timing after the transmission of the sync signal Sync has ended. In other words, the sync signal receiving section 32 stops the start-up and is switched OFF after receiving the sync signal Sync.

The first period shown in FIG. 5 is a period in which the power is supplied to the sync signal receiving section 32, and the sync signal Sync is transmitted in the first period. Further, the second period is a period in which the power is not supplied to the sync signal receiving section 32, and the consumption of the power is reduced. Since the sync signal receiving section 32 is set to the ON state during the first period, it is possible for the sync signal receiving section 32 to receive the sync signal Sync having been transmitted from the projector 1.

As described above, the control section 30 predicts the timing when the sync signal Sync is transmitted, and makes the power supply control circuit 38 switch between the first period and the second period based on the timing thus predicted. In other words, the control section 30 becomes capable of supplying the power to the sync signal receiving section 32 only in the necessary period by switching ON and OFF the supply of the power to the sync signal receiving section 32 using the power supply control circuit 38, and thus, it is possible to reduce the power consumption of the light emitting pen 3 compared to when continuously supplying the power always to the sync signal receiving section 32.

The light receiving signal of the light emitting pen 3 is switched ON or OFF based on the sync signal Sync transmitted from the sync signal transmitting section 14 of the projector 1.

The control section 30 of the light emitting pen 3 makes the light emitting section 35 of the light emitting pen 3 emit light in the second phase P2 and the fourth phase P4, and notifies the projector 1 with the pointing position by the light emitting pen 3. In the third phase P3, the control section 30 of the light emitting pen 3 makes the light emitting section 35 emit light or stops the light emitting section 35 from emitting light based on whether or not the tip switch 33 or the side surface switch 34 is pressed. Then, the control section 30 notifies the projector 1 of the state of the tip switch 33 and the state of the side surface switch 34 with the transitions of the light emitting state of the light emitting section 35 in the third phase P3 in the plurality of reference periods. Further, although the first phase P1 is a phase for synchronization, the control section 30 of the light emitting pen 3 makes the light emitting section 35 emit light or stops the light emitting section 35 from emitting light in the first phase P1 in tandem with the pressing state of the side surface switch 34 or the third phase P3. The light emission of the light emitting section 35 of the light emitting pen 3 is imaged by the imaging section 15 of the projector 1 as the detection light.

The detection section 25 of the projector 1 detects the pointing position by the light emitting pen 3 based on the positions of the infrared light imaged in the second phase P2 and the fourth phase P4. Further, the detection section 25 recognizes the state of the tip switch 33 and the side surface switch 34 of the light emitting pen 3 based on the transitions of the light emitting state of the infrared light imaged in the third phase P3. Then, the detection section 25 controls the image information processing section 18 based on the pointing position by the light emitting pen 3 and the states of the switches 33, 34 thus detected to perform the process of superimposing the pointer and the drawn image, and so on.

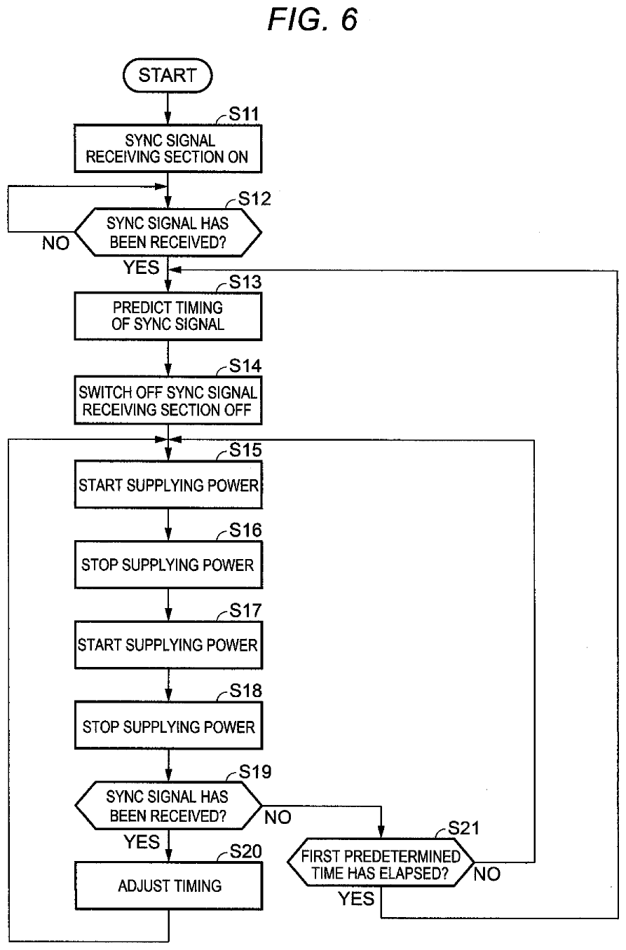

FIG. 6 is a flowchart showing the method of controlling the light emitting pen as the pointing body. The method of controlling the light emitting pen will hereinafter be described with reference to FIG. 6. For example, when the battery 37 is attached to the light emitting pen 3 to apply the power, the light emitting pen 3 starts up, and starts the operation in accordance with the flow shown in FIG. 6.

In the step S11, the control section 30 of the light emitting pen 3 controls the power supply control circuit 38 to supply the sync signal receiving section 32 with the power to switch ON the sync signal receiving section 32 to start up the sync signal receiving section 32 to set the receivable state. The control section 30 continues the state in which the sync signal receiving section 32 is ON to stand ready to receive the sync signal Sync. The state of watching the sync signal Sync is also referred to as a “first receiving mode.”

In the step S12, the control section 30 judges whether or not the sync signal receiving section 32 has received the sync signal Sync. When the sync signal Sync is received, the transition of the process to the step S13 is made. When the sync signal has not been received, the process in the step S12 is repeated. Specifically, as shown in FIG. 5, the sync signal receiving section 32 receives a first sync signal of the first phase P1 in the first reference period and a second sync signal of the first phase P1 in the second reference period. The control section 30 determines that the first sync signal and the second sync signal received by the sync signal receiving section 32 are the sync signal Sync based on the interval between the first sync signal and the second sync signal.

In the step S13, the control section 30 predicts the timing when the sync signal Sync is transmitted from the sync signal transmitting section 14 of the projector 1 based on the sync signal Sync having been received by the sync signal receiving section 32.

In the step S14, the control section 30 controls the power supply control circuit 38 to stop the supply of the power to the sync signal receiving section 32 to stop the sync signal receiving section 32 to be set to the OFF state. Subsequently, the control section 30 controls the power supply control circuit 38 based on the result thus predicted to switch between the first period in which the power is supplied to the sync signal receiving section 32 and the second period in which the supply of the power to the sync signal receiving section 32 is restricted. The state in which the supply of the power to the sync signal receiving section 32 is performed in the first period and the supply of the power is stopped in the second period as described above is also referred to as a “second receiving mode.” The sync signal receiving section 32 can receive the sync signal in the first period, and in the second period, the sync signal receiving section 32 can suppress the consumption of the power.

In the step S15, the control section 30 controls the power supply control circuit 38 to supply the sync signal receiving section 32 with the power at the timing based on the prediction result in order to receive the first sync signal, namely first one of the sync signals. Specifically, in the first phase P1 in the first reference period, the sync signal receiving section 32 is switched ON at the timing based on the prediction result.

In the step S16, the control section 30 controls the power supply control circuit 38 to stop the supply of the power to the sync signal receiving section 32 at the timing based on the prediction result at the end of the reception of the first sync signal, namely first one of the sync signals. Specifically, in the first reference period, the sync signal receiving section 32 is switched OFF at the timing based on the prediction result.

In the step S17, the control section 30 controls the power supply control circuit 38 to supply the sync signal receiving section 32 with the power at the timing based on the prediction result in order to receive the second sync signal, namely second one of the sync signals. Specifically, in the first phase P1 in the second reference period, the sync signal receiving section 32 is switched ON at the timing based on the prediction result.

In the step S18, the control section 30 controls the power supply control circuit 38 to stop the supply of the power to the sync signal receiving section 32 at the timing based on the prediction result at the end of the reception of the second sync signal, namely second one of the sync signals. Specifically, in the second reference period, the sync signal receiving section 32 is switched OFF at the timing based on the prediction result.

In the step S19, the control section 30 judges whether or not the sync signal receiving section 32 has received the sync signal Sync in the steps S15 through S18. When the sync signal Sync has been received, the transition of the process to the step S20 is made. In contrast, when the sync signal receiving section 32 has not received the sync signal Sync as a result that the projector 1 stops the transmission of the sync signal Sync or the sync signal Sync is blocked by an obstacle or the like, the transition of the process to the step S21 is made.

In the step S20, the control section 30 adjusts the timing of the sync signal Sync predicted in the step S13. Since the control section 30 adjusts the timing every 32 phases as described above, the timing is prevented from being shifted due to error accumulation. Subsequently, the control section 30 returns the process to the step S15 to repeat the reception of the sync signal. It should be noted that although not shown in the drawings, the control section 30 makes the light emitting section 35 emit light in the second phase P2 and the fourth phase P4 in sync with the sync signal Sync thus received.

When it has been determined in the step S19 that the reception of the sync signal Sync is false, and the transition of the process to the step S21 has been made, the control section 30 determines whether or not first predetermined time has elapsed from when the reception of the sync signal Sync has become unachievable. When the first predetermined time has elapsed, the transition of the process to the step S11 is made. When the first predetermined time has not elapsed, the transition of the process to the step S15 is made. The first predetermined time is, for example, 4.5 second.

As described hereinabove, according to the light emitting pen 3, the method of controlling the light emitting pen 3, and the interactive system 100 related to the present embodiment, the following advantages can be obtained.

(1) According to the present embodiment, since the control section 30 predicts the timing when the sync signal Sync is transmitted from the projector 1 to make the power supply control circuit 38 switch between the supply and the stop of the power to the sync signal receiving section 32, it becomes possible to supply the power to the sync signal receiving section 32 only in the necessary period, and it is possible to reduce the power consumption of the light emitting pen 3 compared to when always supplying the power to the sync signal receiving section 32.

(2) According to the present embodiment, since the sync signal Sync includes the first sync signal and the second sync signal transmitted at a predetermined time interval, it is possible to determine the sync signal based on the reception interval between the first sync signal and the second sync signal.

(3) According to the present embodiment, since the control section 30 makes the transition to the first receiving mode in which the supply of the power to the sync signal receiving section 32 continues when the first predetermined time has elapsed while the sync signal receiving section 32 fails to receive the sync signal Sync, it becomes possible to newly receive the sync signal Sync.

(4) According to the present embodiment, since the control section 30 re-predicts the timing when the sync signal Sync is newly transmitted when the sync signal Sync has been received during the first receiving mode, it becomes possible to switch between the first period in which the power is supplied at the appropriate timing and the second period in which the supply of the power is stopped.

(5) According to the present embodiment, since the light emitting section 35 performs the process of emitting the infrared light in sync with the sync signal Sync having been received by the sync signal receiving section 32, it is possible for the projector 1 to image the infrared light at an appropriate timing.

### Modified Example

Further, the embodiment described above can also be modified as follows.

In the embodiment described above, the control section 30 makes the power supply control circuit 38 supply and stop the power to the sync signal receiving section 32, but this is not a limitation, and it is also possible to arrange to perform limitation of the supply of the power such as reduction of the power to be supplied instead of stopping the supply of the power. Also in this case, it is possible to suppress the power consumption of the light emitting pen 3 compared to when always supplying constant power to the sync signal receiving section 32.

It is assumed in the embodiment described above, there is provided the configuration in which the projector 1 is provided with the sync signal transmitting section 14 for transmitting the sync signal to the light emitting pen 3 as the pointing body, the image projection section 19 for projecting the image, and the imaging section 15 for taking the image in sync with the sync signal, but it is also possible to adopt a configuration not including the image projection section 19. For example, the image pointed by the light emitting pen 3 is displayed by the display device such as a liquid crystal panel, and by disposing the detection device provided with the imaging section 15 and the sync signal transmitting section 14 so as to be able to take the image, it is possible to detect the pointing position by the light emitting pen 3 with respect to the image displayed by the display device.

Although in the embodiment described above, the light emitting pen 3 is provided with the light emitting section 35 for emitting the infrared light in sync with the sync signal transmitted from the projector 1 as a processing section, the pointing body is not limited to the light emitting pen 3 provided with the light emitting section 35. For example, it is also possible for the pointing body to be provided with a configuration in which the imaging section 15 for periodically performing imaging in sync with the sync signal transmitted from the projector 1 is provided as the processing section. By combining the pointing body and the projector 1 for periodically projecting a pattern image in sync with the sync signal, the imaging result obtained by taking the pattern image with the pointing body can be used for detecting the pointing position.

Although in the embodiment described above, the transmissive liquid crystal light valves 22R, 22G, and 22B are used as the light modulation devices, it is also possible to use reflective light modulation devices such as reflective liquid crystal light valves. Further, it is also possible to use a digital mirror device or the like for modulating the light emitted from the light source 21 by controlling the emission direction of the incident light for every micromirror as a pixel. Further, the configuration of providing the plurality of light modulation devices for the respective colored light beams is not a limitation, but it is also possible to adopt a configuration of modulating the plurality of colored light beams with a single light modulation device in a time-sharing manner.

Hereinafter, the contents derived from the embodiments will be described.

The pointing body is a pointing body configured to point an image displayed including a receiving section configured to receive a sync signal periodically transmitted, a processing section configured to perform a process in sync with the sync signal received by the receiving section, and a control section configured to control supply of power to the receiving section, wherein the control section predicts timing when the sync signal is transmitted based on the sync signal received by the receiving section, and switches between a first period in which the power is supplied to the receiving section and a second period in which supply of the power to the receiving section is restricted based on the timing predicted.

According to the present configuration, since the timing when the sync signal is transmitted is predicted, the power is supplied to the receiving section in the first period, and the supply of the power to the receiving section is restricted in the second period, it becomes possible to supply the power to the receiving section only in a necessary period, and it is possible to reduce the power consumption of the pointing body.

In the pointing body described above, the sync signal may include a first sync signal, and a second sync signal to be transmitted at a predetermined interval with the first sync signal.

According to the present configuration, it is possible to determine the sync signal based on the reception interval between the first sync signal and the second sync signal.

In the pointing body described above, when a predetermined time elapsed while the receiving section fails to receive the sync signal, the control section may make a transition to a first receiving mode in which the supply of the power to the receiving section is continued to watch reception of the sync signal by the receiving section.

According to the present configuration, since the control section makes the transition to a standby mode when the predetermined time elapsed while the receiving section fails to receive the sync signal, it becomes possible to newly re-receive the sync signal.

In the pointing body described above, when the control section received the sync signal during the first receiving mode, the control section may re-predict the timing when the sync signal is transmitted.

According to the present configuration, since the timing when the sync signal is transmitted is newly re-predicted, it becomes possible to switch between the first period and the second period at an appropriate timing.

In the pointing body described above, the processing section may perform a process of emitting detection light in sync with the sync signal.

According to the present configuration, since the processing section emits the detection light in sync with the sync signal received, the detection light can be detected at an appropriate timing.

The method of controlling a pointing body is a method of controlling a pointing body configured to point an image displayed including the steps of receiving, with a receiving section, a sync signal periodically transmitted, predicting timing when the sync signal is transmitted based on the sync signal received, and switching, based on the timing predicted, between a first period in which power is supplied to the receiving section and a second period in which supply of the power to the receiving section is restricted.

According to the present method, since the timing when the sync signal is transmitted is predicted, the power is supplied to the receiving section in the first period, and the supply of the power to the receiving section is restricted in the second period, it becomes possible to supply the power to the receiving section only in a necessary period, and it is possible to reduce the power consumption of the pointing body.

In the method of controlling the pointing body described above, the sync signal may include a first sync signal, and a second sync signal to be transmitted at a predetermined interval with the first sync signal.

According to the present method, it is possible to determine the sync signal based on the reception interval between the first sync signal and the second sync signal.

In the method of controlling the pointing body described above, when a predetermined time elapsed while the receiving section fails to receive the sync signal, a transition to a first receiving mode in which the supply of the power to the receiving section is continued to watch reception of the sync signal by the receiving section may be made.

According to the present method, since the transition to a standby mode when the predetermined time elapsed while the receiving section fails to receive the sync signal is made, it becomes possible to newly re-receive the sync signal.

In the method of controlling the pointing body described above, when the sync signal was received during the first receiving mode, the timing when the sync signal is transmitted may be re-predicted.

According to the present method, since the timing when the sync signal is transmitted is newly re-predicted, it becomes possible to switch between the first period and the second period at an appropriate timing.

In the method of controlling the pointing body described above, detection light may be emitted in sync with the sync signal received by the receiving section.

According to the present method, since the detection light is emitted in sync with the sync signal received, the detection light is detected at an appropriate timing.

The interactive system includes the pointing body described above, and a projector having a sync signal transmitting section configured to transmit the sync signal to the pointing body, an image projection section configured to project the image, and an imaging section configured to take the image in sync with the sync signal.

According to the present configuration, it is possible to provide an interactive system capable of reducing the power consumption.

What is claimed is:

1. A pointing body configured to point an image displayed comprising:
a receiving section configured to receive a sync signal periodically transmitted;
a processing section configured to perform a process in sync with the sync signal received by the receiving section; and
a control section configured to control supply of power to the receiving section, wherein
the control section predicts timing when the sync signal is transmitted based on the sync signal received by the receiving section, and switches between a first period in which the power is supplied to the receiving section and a second period in which supply of the power to the receiving section is restricted based on the timing predicted.

2. The pointing body according to claim 1, wherein
the sync signal includes a first sync signal, and a second sync signal to be transmitted at a predetermined interval with the first sync signal.

3. The pointing body according to claim 1, wherein
when a predetermined time elapsed while the receiving section fails to receive the sync signal, the control section makes a transition to a first receiving mode in which the supply of the power to the receiving section is continued to watch reception of the sync signal by the receiving section.

4. The pointing body according to claim 3, wherein
when the control section received the sync signal during the first receiving mode, the control section re-predicts the timing when the sync signal is transmitted.

5. The pointing body according to claim 1, wherein
the processing section performs a process of emitting detection light in sync with the sync signal.

6. A method of controlling a pointing body configured to point an image displayed, the method comprising:
receiving, with a receiving section, a sync signal periodically transmitted;
predicting timing when the sync signal is transmitted based on the sync signal received; and
switching, based on the timing predicted, between a first period in which power is supplied to the receiving section and a second period in which supply of the power to the receiving section is restricted.

7. The method of controlling the pointing body according to claim 6, wherein
the sync signal includes a first sync signal, and a second sync signal to be transmitted at a predetermined interval with the first sync signal.

8. The method of controlling the pointing body according to claim 6, wherein
when a predetermined time elapsed while the receiving section fails to receive the sync signal, a transition to a first receiving mode in which the supply of the power to the receiving section is continued to watch reception of the sync signal by the receiving section is made.

9. The method of controlling the pointing body according to claim 8, wherein
when the sync signal is received during the first receiving mode, timing when the sync signal is transmitted is re-predicted.

10. The method of controlling the pointing body according to claim 6, wherein
detection light is emitted in sync with the sync signal received by the receiving section.

11. An interactive system comprising:
the pointing body according to claim 1; and
a projector having a sync signal transmitting section configured to transmit the sync signal to the pointing body, an image projection section configured to project the image, and an imaging section configured to take the image in sync with the sync signal.
